(19) United States
(12) Patent Application Publication
(10) Pub. No.: US 2007/0234906 A1
(43) Pub. Date: Oct. 11, 2007

(54) Composite Silencer Base for a Vacuum Loader

(75) Inventor: Thomas M. DeMarco, Woodstock, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DEMARCO MAX VAC CORPORATION, McHenry, IL (US)

(21) Appl. No.: 11/756,332

(22) Filed: May 31, 2007

Related U.S. Application Data
(63) Continuation-in-part of application No. 11/435,661, filed on May 17, 2006.
Application No. 11/435,661 is a continuation-in-part of application No. 11/162,024, filed on Aug. 25, 2005.
Application No. 11/162,024 is a continuation-in-part of application No. 10/389,792, filed on Mar. 17, 2003, now Pat. No. 6,936,085.

(51) Int. Cl. B07B 7/04; B01D 46/02

(52) U.S. Cl. 96/382; 209/133; 96/384; 96/385

(57) ABSTRACT

An industrial vacuum loader is equipped with a composite silencer base to reduce unwanted noise. The composite silencer base includes a reactive dampening section and an absorptive dampening section. A blower (or vacuum pump) is mounted directly to the composite silencer base to further reduce unwanted noise generated by the blower (or vacuum pump).

### CROSS REFERENCE TO RELATED APPLICATIONS

This application is a continuation-in-part of U.S. patent application Ser. No. 11/435,661 filed May 17, 2006, entitled “Vacuum Loader with a Louvered Tangential Cyclone Separator,” which claims priority benefit of U.S. patent application Ser. No. 11/162,024 filed Aug. 25, 2005 en titled “Vacuum Loader,” and U.S. patent application Ser. No. 10/389,792 filed Mar. 17, 2003, now U.S. Pat. No. 6,936,085 issued Aug. 30, 2005 entitled “Vacuum Loader.” Each of U.S. patent application Ser. No. 10/389,792, U.S. patent application Ser. No. 11/162,024, and U.S. patent application Ser. No. 11/435,661 are hereby incorporated by reference.

### BACKGROUND

This disclosure pertains to machines for removing or transferring dry and wet particulates and, more particularly, to an industrial vacuum cleaner, loader, pneumatic conveyor, or industrial dust collector.

In industry, voluminous amounts of particulate matter, debris, and waste are emitted during machining, foundry, milling, shipment, warehousing, assembling, fabricating, and other manufacturing operations. Particulates of dust emitted during a manufacturing operation can include metal slivers, plastic chips, wood shavings, dirt, sand, and other debris. Dust accumulates on floors, machines, packaging materials, equipment, food, and personnel. Dust is carried and circulated in the air and can be injurious to the health and safety of operating personnel and other on-site employees. Dust can damage, erode, and adversely affect the efficiency and operability of equipment. It can also create a fire hazard and cause explosions in some situations, such as in grain elevators. Voluminous amounts of dust can pollute the atmosphere. Dust may also impair the quality of the products manufactured.

Dust emissions are not only dangerous and troublesome, but are particularly aggravating and grievous where relatively dust-free conditions and sterile environments are required such as in medical supply houses, the electronics industry, and in food-processing plants.

Over the years a variety of vacuum loaders, industrial dust collectors and other equipment have been suggested for removing industrial dust and debris and for other purposes. Typically, vacuum loaders, dust collectors and equipment have at least one filter compartment with one or more filters therein. Many different types of filters have been used in vacuum loaders, industrial dust collectors and other equipment. These prior vacuum loaders, dust collectors and equipment have been met with varying degrees of success. One problem common to all prior vacuum loaders, dust collectors and equipment is that large amounts of unwanted noise are generated during the process of removing particulates.

### SUMMARY

The vacuum loader described herein includes a composite silencer base having a reactive sound dampening section and an absorptive sound dampening section. A blower (or vacuum pump) is mounted directly to the composite silencer base to further reduce unwanted noise generated by the blower (or vacuum pump).

As used in this patent application, the term “dust” includes particulate matter, debris and/or any other type of waste or non-waste material. The dust can comprise particulates of fiberglass, fibrous materials, powder, coal and other minerals, metal slivers and chips, sand, soda ash, steel shot, talconite pellets and/or any other particulate material.

The term “fluid” as used herein includes air and other gases and water and other liquids.

The terms “dedust” and “dedusted” as used herein include removing a substantial amount of dust.

The term “fines” as used herein includes small, minute, particulates.

The term “bulk” as used herein includes the major portion of the vacuumed materials.

A more detailed explanation of the invention is provided in the following description and appended claims taken in conjunction with the accompanying drawings.

### BRIEF DESCRIPTION OF THE DRAWINGS

FIG. 1 is a perspective view of a vacuum loader having a filter compartment with side access doors in accordance with principles of the present invention;

FIG. 2 is a left side view of the vacuum loader of FIG. 1;

FIG. 3 front view of the vacuum loader of FIG. 1 with a diagrammatic illustration of the side access doors;

FIG. 4 is a back view of vacuum loader of FIG. 1;

FIG. 5 is a top plan view of the vacuum loader of FIG. 1;

FIG. 6 is an enlarged fragmentary perspective view of the access openings of the filtering compartment with the doors open illustrating a pair of right filter braces being manually pivoted to a partially open position;

FIG. 7 is an enlarged fragmentary perspective view of the access openings of the filtering compartment with the doors open a pair of right filter braces in an open position for inserting or removing the right upright tubular filter;

FIG. 8 is a partially cut-away perspective view of a silencer base of the vacuum loader of FIG. 1;

FIG. 9 is a plan view of the silencer base of FIG. 8;

FIG. 10 is a side elevational view of the silencer base of FIG. 8; and

FIG. 11 is an end view of the silencer base of FIG. 8.

### DETAILED DESCRIPTION

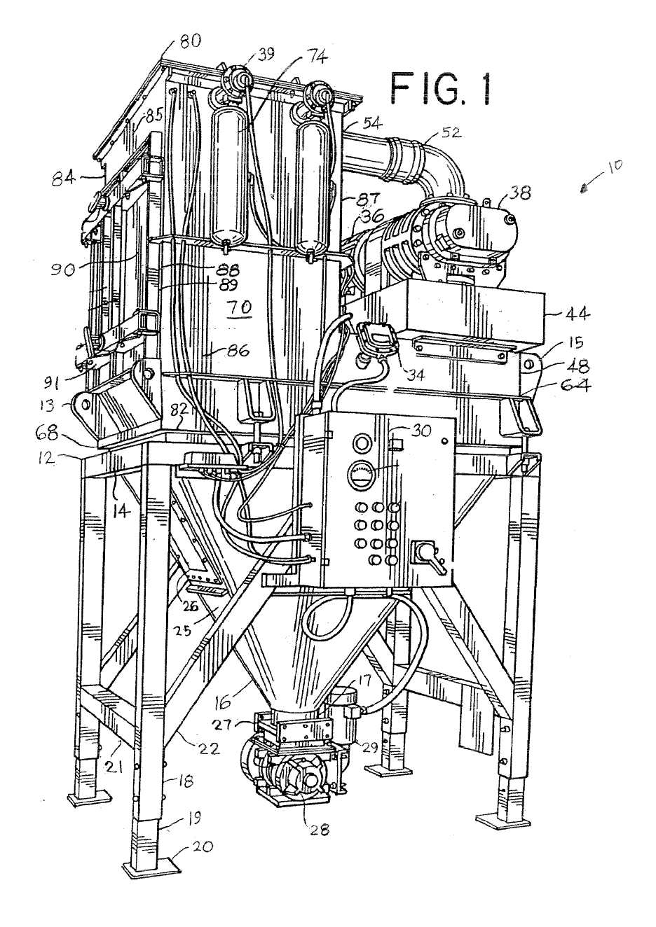

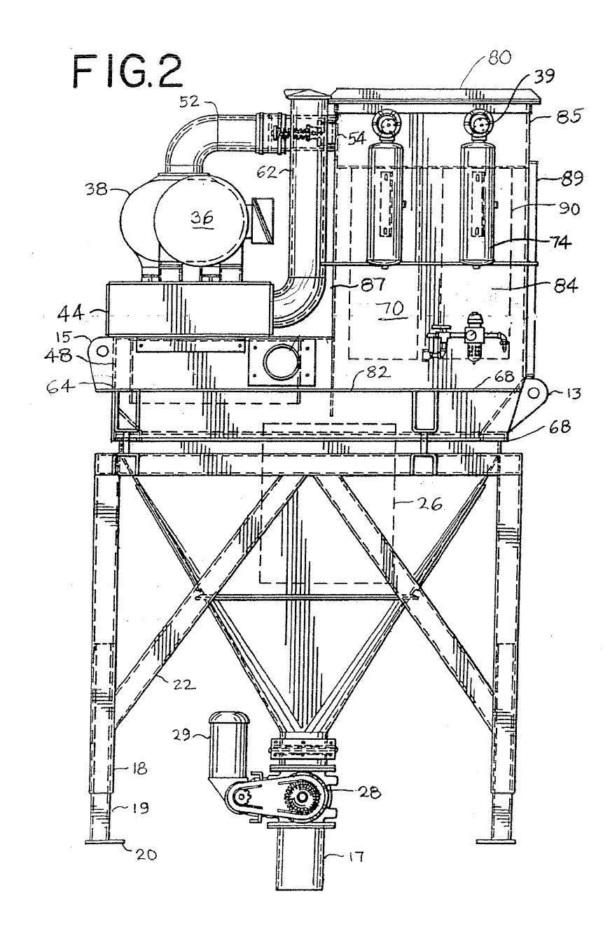

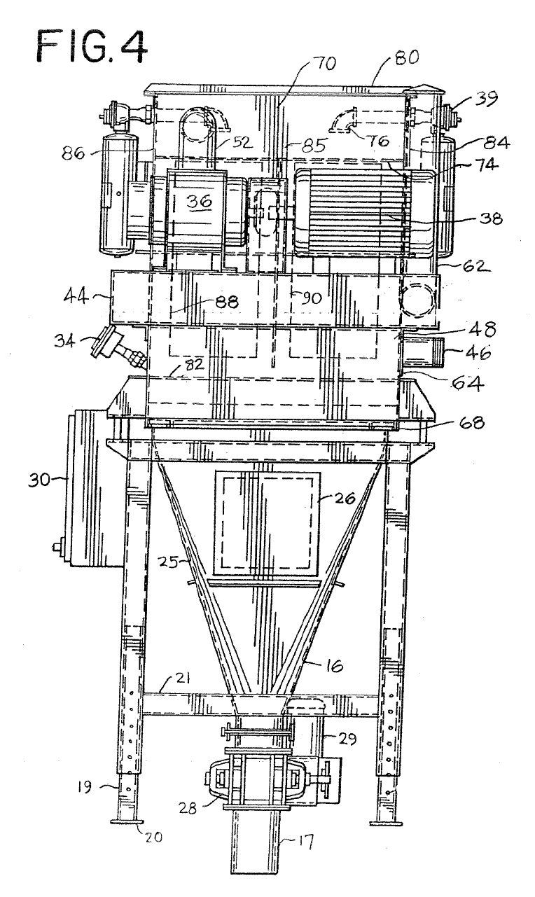

A vacuum loader 10 (FIGS. 1-5) provides a heavy-duty vacuum-operated machine, industrial vacuum cleaner, vacuum loader and vacuum conveyor or pneumatic conveyor to efficiently remove, effectively collect, and safely dispose of or convey (transfer) dust, particulate matter, debris, and other waste or non-waste material. The vacuum loader can be made of steel or other metal. Other materials can be used. The vacuum loader 10 can have a frame assembly 12 with a base 14 which receives a hopper 16 comprising a bin such as an end dump hopper. The hopper 16 has at bottom end with a hopper outlet 17. In the illustrative embodiment, the hopper 16 is positioned below and supports a solids-gas separator compartment 48, as well as a filter compartment 70. The hopper 16 may comprise a stationary bin, a moveable bin, a portable bin, and/or a towable bin.

The frame assembly 14 and hopper 16 can be equipped with flanged plates 13 and 15 (FIG. 1) with openings therein and/or with forklift-channels for receiving and being moved by tines of a forklift truck. The frame assembly 14 can have telescoping upright legs 18-19 with feet 20 and support members comprising lateral bars 21 and diagonal braces 22. A downwardly inclined frustoconical portion 25 of the hopper 16 may have a discharge door 26, a cutoff gate 27, and a rotary airlock valve 28 operatively connected to and controlled by a motor 29. A control panel 30 can be mounted on the frame assembly 14. The control panel 30 may control, activate, and deactivate a high level control 34, the motor 29, the rotary airlock valve 28, a blower motor 36, vacuum pump 38, air injectors 39, etc. The control panel 30 may also be connected to a sensor and/or a limit switch to automatically shut off a blower motor 36 when discharged collected dust in the hopper 16 has reached a preselected level.

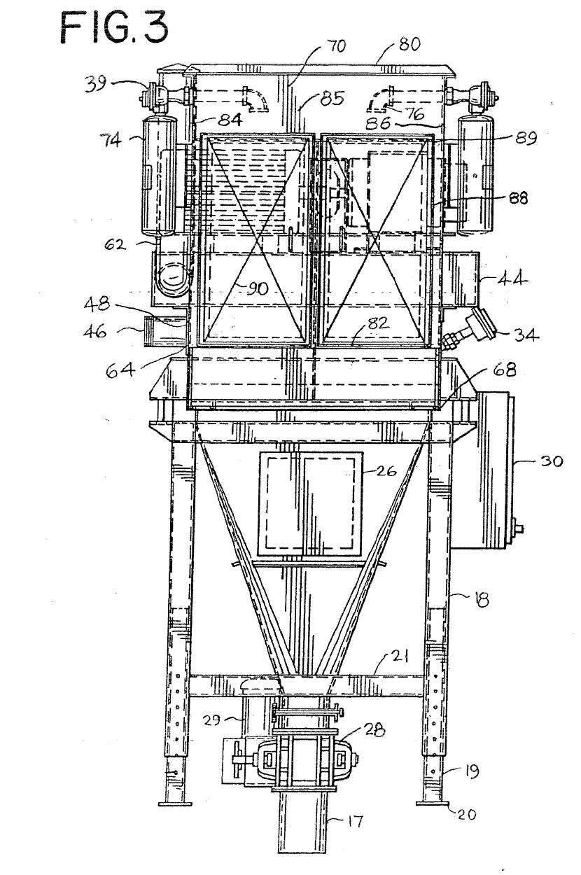

The blower motor 36 (FIG. 1) and vacuum pump 38 may be mounted on a sound attenuating device or silencer base 44. The blower motor 36 is operatively connected to the vacuum pump 38 by a drive coupling 43 (FIG. 5). The vacuum pump 38 creates a vacuum (suction) to draw dust and direct influent dusty air (air laden with particulates of dust) through one or more inlet conduits, such as through a primary inlet conduit 46 (FIGS. 3-5). The primary inlet conduit 46 provides at least one material inlet port into the solids-gas separation compartment 48. In the illustrative embodiment, the primary inlet conduit 46 is tangential to the solids-gas separation compartment 48. The primary inlet conduit 46 directs the flow of the influent dusty gas stream inwardly to create a turbulent or swirling action of the dusty gas stream in the solids-gas separation compartment 48.

The blower motor 36 may be connected by an overhead blower line 52 (FIG. 1) which communicates with discharge outlet conduit 54 of the filter compartment 70.

Silencer Base Assembly

As mentioned, the vacuum loader 10 can be equipped with a sound attenuating device or silencer base 44 (FIGS. 1-4) that can be connected to the blower motor 36 and the exhaust pipe 62 to attenuate, muffle, suppress, and decrease noise and vibrations from the blower motor 36 and/or vacuum pump 38, and dampen the noise and sound of purified gases passing and being discharged through the exhaust pipe 62. The silencer base 44 may be similar to the silencer base described in applicant's U.S. Pat. No. 4,786,299 which is hereby incorporated by reference.

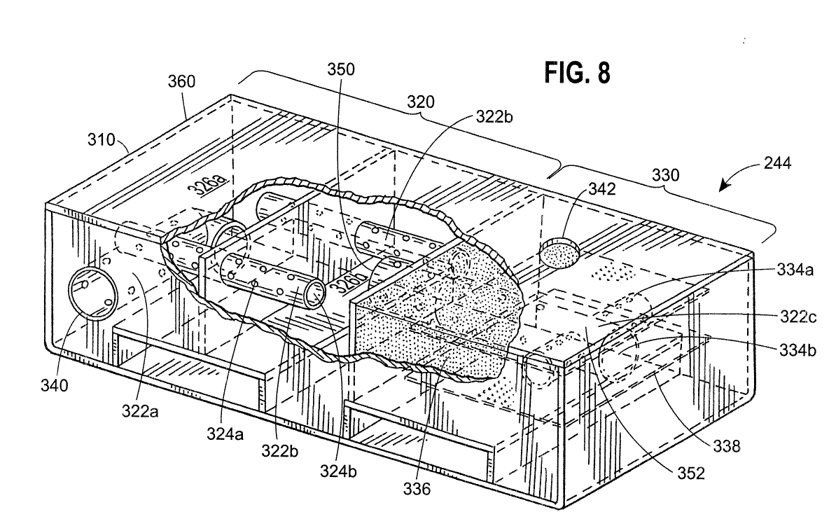

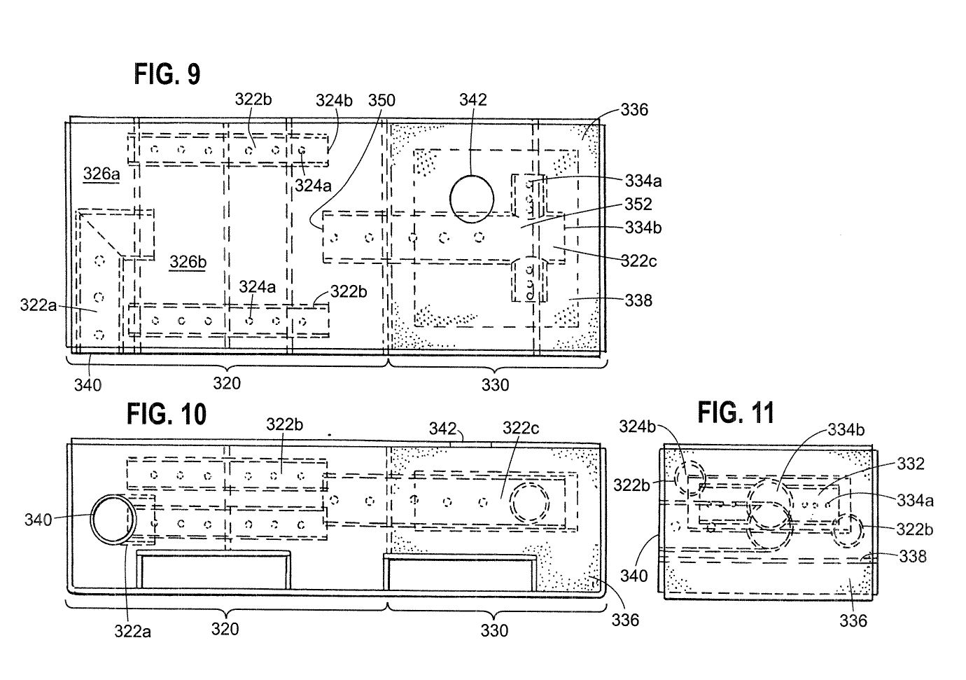

Alternatively, the vacuum loader may include a composite silencer base 244, as shown in FIGS. 8-11. The composite silencer base 244 includes a housing 310 that surrounds two dampening sections, a reactive section 320 and an absorptive section 330, which are fluidly connected in series. Generally, dedusted air flows from the blower motor 36 to an inlet 340 in the reactive section 320, through the reactive section 320, through the absorptive section 330 and out of an outlet 342 in the absorptive section 330. However, the flow could be reversed if desired (i.e., dedusted air could flow first through the absorptive section 330 and then through the reactive section 320). Regardless, the reactive section 320 and the absorptive section generally attenuate different frequencies of sound energy, thereby attenuating a greater range of operational noise frequencies than silencer bases that have only one type of attenuation (i.e., either reactive, absorptive, or otherwise).

The reactive section 320 may include a series of pipes 322a, 322b having a plurality of openings 324a, 324b of various sizes. A first L-shaped pipe 322a transports dedusted air from the inlet 340 into the reactive section 320. Other pipes 322b transport dedusted air from one reactive chamber 326a to other reactive chambers 326b within the reactive section 320. In the disclosed embodiment, the other pipes 322b are disposed parallel to one another and generally positioned on opposite sides of the reactive section 320 of the housing 310. The reactive section 320 reflects acoustic waves (operational noise) at the locations where the dedusted air expands, contracts, or branches. For example, the dedusted air expands when exiting a pipe through a large opening 324b or a small opening 324a into the chamber 326a, 326b and the dedusted air may contract when entering a small opening 324a or a large opening 324b from the chamber 326a, 326b. Furthermore, as the dedusted air flows through the pipes 322a, 322b, the dedusted air may branch and exit different openings 324a, 324b. In this manner, the reactive section 320 attenuates unwanted sound energy (generally lower frequencies) by changing the velocity and direction of the flow of the dedusted gas and reflecting the sound energy back towards the source of the sound energy. By using various sized pipes 322a,b, openings 324a,b, and chambers 326a,b, the reactive section attenuates a variety of frequencies. Often, the flow of dedusted gas will reverse direction and/or impinge on structural surfaces within the reactive section, thereby further attenuating the operational noise. In the disclosed embodiment, the reactive section 320 generally attenuates frequencies between approximately 200 Hz and approximately 2000 Hz.

After exiting the reactive section 320 through another pipe 322c the dedusted air flows into the absorptive section 330. The pipe 322c may have an inlet 350 in the reactive section 320 and a generally T-shaped outlet 352 in the absorptive section. In the disclosed embodiment, the pipe 322c is disposed generally parallel to and between the pipes 322b disposed in the reactive section 320. The absorptive section 330 generally attenuates unwanted noise by dissipating sound energy as heat. The pipe 332c may include a plurality of openings 334a, 334b, to direct the dedusted air into an absorptive material 336. The absorptive material 336 is a generally porous, permeable and/or fibrous media that absorbs sound energy and transforms the sound energy into heat. Virtually any fibrous or sheet sound absorbing material may be used, for example, fiberglass and/or mineral wool. The absorptive section 330 generally attenuates higher frequency sound waves than the reactive section 320. Virtually any material that exhibits absorptive qualities may be used in the absorptive section 330. For example, fiberglass insulation is one such absorptive material. Additionally baffles or louvers 338 may further break up unwanted sound energy in the absorptive section 330 thereby enhancing noise reduction in the absorptive section 330. In the disclosed embodiment, the absorptive section generally attenuates frequencies above approximately 2000 Hz.

In addition to the two different attenuating sections, the silencer base 244 may include thick outer housing walls 360 (up to ½ inch thick or more) to act as sound barriers which keep the sound energy of the dedusted air from escaping through the outer housing walls 360. Furthermore, the thick outer housing walls 360 provide structural support to the silencer base 244 when mounting the blower motor 36 or vacuum pump 38 (FIG. 1) thereto. By mounting the blower motor 36 and/or the vacuum pump 38 directly to the silencer base 44, the silencer base 44 is integrated into the vacuum loader as a structural member and vibrations of the blower motor 36 and/or vacuum pump 38 are transmitted directly to the silencer base 44 thereby further reducing operational noise. Additionally, when the blower motor 36 and/or vacuum pump 38 are mounted directly to the silencer base 44, the dedusted air has a shorter distance to travel between the blower motor 36 and the silencer base 44 again reducing transmission of unwanted noise.

While the silencer base 44 has thus far been disclosed as including a single reactive compartment 320 including a plurality of chambers 326a, 326b and a single absorptive compartment 330, an alternative embodiment of the silencer base 44 may include a plurality of reactive and/or absorptive compartments 320, 330.

Solids-Gas Separation Compartment

The solids-gas separation compartment 48 (FIGS. 1-5) contains one or more solids-gas separators, preferably comprising a tangential cyclone separator 64 with an open bottom providing a circular or circumferential bottom outlet 66 (FIG. 5) providing an outlet port about its circular edge and periphery to discharge larger particulates of dust into the hopper 16. The tangential cyclone separator 64 preferably comprises a perforated plate or foraminous tangential cyclone separator, such as described in applicant's U.S. Pat. No. 6,936,085 which is hereby incorporated by reference. The tangential cyclone separator 64 can have angular perforations, such as described in applicant's U.S. patent application Ser. No. 11/162,064 which is hereby incorporated by reference. The tangential cyclone separator 64 can comprise a louvered tangential cyclone separator comprising a circular array of aliquotly spaced upright slats providing louvers.

Desirably, the solids-gas separator compartment 48 provides gross separation to remove large particulates (particles) of dust from an influent dusty gas stream (e.g. dust laden air) to attain a grossly separated effluent dusty stream having a lower concentration of particulates of dust by weight than the influent dusty stream.

Filter Compartment

The partially dedusted air can exit the solids-gas separating compartment 48 and pass (flow) upwardly through the open bottoms 68 (FIGS. 1-5) of the filter compartment 70, such as described in applicant's U.S. Pat. No. 6,569,217 which is hereby incorporated by reference. The filter compartment 70 contains one or more filters 72 (FIGS. 5-7), preferably a set, series, or array of filters, such as four upright tubular filters 72. The partially dedusted gas stream of air can pass (flow) upwardly and be filtered by filters 72 in the filter compartment 70 to remove most of the remaining smaller particulates (fines) of dust in the dusty stream. The filtered dedusted air can pass (flow) upwardly and exit and be discharged from the filter compartment 70 through the filter outlet 54 (FIG. 1). The filtered air can be drawn through the blower line 52 by the vacuum pump 38 and can be discharged to the surrounding area and atmosphere by the exhaust pipe 62.

The filter compartment 70 can have a filter chamber that contains a plurality, set, or array of canister filters (annular, tubular or cartridge filters) 72 (FIGS. 5-7). The partially dedusted gas stream can flow upwardly, annularly, and laterally through each filter 72 of the filter compartment 70 to remove substantially all the remaining particulates of dust. In the illustrative embodiment, the filter compartment 70 contains a set of four canister filters 72 which are positioned in a circular array. While the preceding arrangement is preferred for best results, more or less filters or different types of filters can be used, if desired. The set of filters in the filter compartment 70 remove the fines (minute fine dust particles) and substantially all the remaining particulates of dust in the dusty gas stream flowing through the filter compartment 70 to produce a dedusted purified gas (air) stream.

A discharge outlet conduit 54 (FIG. 11) can be connected to and communicate with the upper clean air chamber (plenum) of the filter compartment 70 to provide an outlet and passageway through which the purified, dedusted and filtered air is drawn from the filter compartment 70 via the blower line 52 into the vacuum pump 38 and silencer base 44 for discharge via the exhaust pipe 62 to the atmosphere or area surrounding the industrial dust collector.

Reverse pulse filter cleaners comprising air injectors 39 (FIGS. 1-5) can be mounted and extend to the interior of the filter compartment 70 to periodically inject intermittent blasts comprising pulses of compressed clean air upon the inside (interior) of the filters 72 to help clean the filters 72. The injectors can be connected by pneumatic tubes or conduits to an air supply source 74, such as compressed air tanks comprising compressed air canisters, or an auxiliary compressor. In the illustrative embodiment, there is a circular array or set of four upright compressed air canisters (compressed air tanks) 74 mounted about the exterior surface of the filter compartment 70 and there is a circular set or array of four downwardly facing, overhead air injectors 76 (FIGS. 3-5) positioned above the centers of the filters 72 and connected to the compressed air canisters to sequentially inject pulses of compressed air into the center of the filters 72 to shake loose the dust collected, accumulated, on the filter 72. More or less air injectors and compressed air canisters can be used. While the illustrated arrangement is preferred for best results, a different arrangement can be used, if desired. The filtered removed dust collected and accumulated on the bottom of the filter compartment 70 can be discharged into the hopper 16 when the blower motor 36 is turned off or by actuation of the control panel 31.

Operation of Vacuum Loader

In operation, air laden with entrained particulates of debris, waste and other dust is drawn by the blower motor 36 into the solids-gas separation compartment 48. dusty air swirls tangentially along the inside surface of the gas-solids separation compartment 48 and ejects the effluent partially dedusted air upwardly into the filter compartment 70. The filters can filter the particulates (dust) to under 1 micron, preferably at an efficiency of about 99.5% at about 0.33 microns. Collected dust on the surface of the filters can be reverse air-pulse cleaned by variable pulse speed, air pulse injectors. The removed particulates are discharged by gravity downwardly into the hopper 16.

Filter Doors

As shown in FIGS. 1-5, the filter compartment 70 is spaced laterally away and offset from the solids-gas separating compartment 48 and communicates with the outlet port 66 (FIG. 5) of the solids-gas separation compartment. The filter compartment 70 preferably can have an imperforate generally flat, planar or domed top portion 80 (FIGS. 1-5), a bottom portion 82, and upright lateral side portions 84-87 that extend generally vertically between and connect the top portion 80 and the bottom portion 82. The upright side portions 84 comprise a motor-facing side portion 87 facing the solids-gas separating compartment 48 and the silencer base 44, an accessible side portion 85 positioned opposite the motor-facing portion 87, and opposite facing injector supporting side portions 84 and 86 extending between and connected to the motor-facing side portion 87 and the accessible side portion 85.

Desirably, the filter compartment 70 is equipped with a filter door system comprising an accessible side portion 85 (FIGS. 1-7) with upright door frames 89 which provide and define upright, similar size, laterally aligned, rectangular lateral, side access filter openings 88 for accessing the upright tubular filters. Advantageously, the filter door system has a set of laterally aligned, similar size, upright lateral side access filter doors 90 that are pivotally connected and hinged to the accessible upright lateral side portion of the filter compartment 70 for selectively opening and closing the side access openings 88 for ingress and egress of the filters 72 to permit insertion, removal, inspection and/or maintenance of the filters 72. In the illustrative embodiment, the upright lateral side access doors 90 open in a direction away from the silencer base 44 and blower motor 36. The upright lateral side access doors 90 preferably have upper sections that are positioned at a level higher than the solids-gas separation compartment 48 and can have a lower generally horizontal pivotal flange 91.

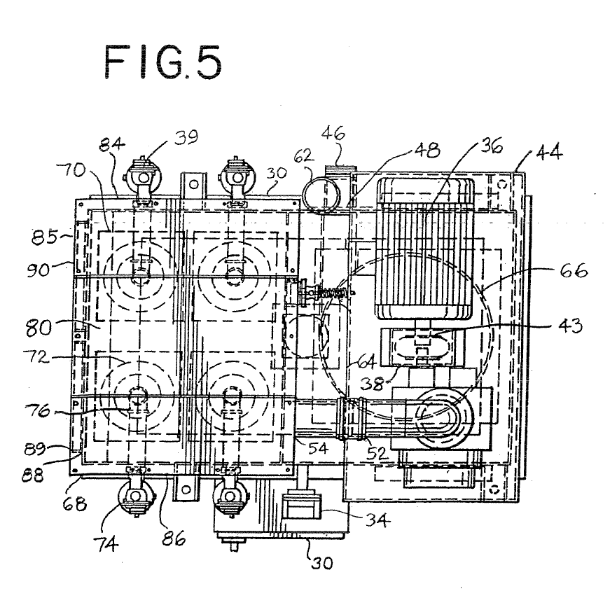

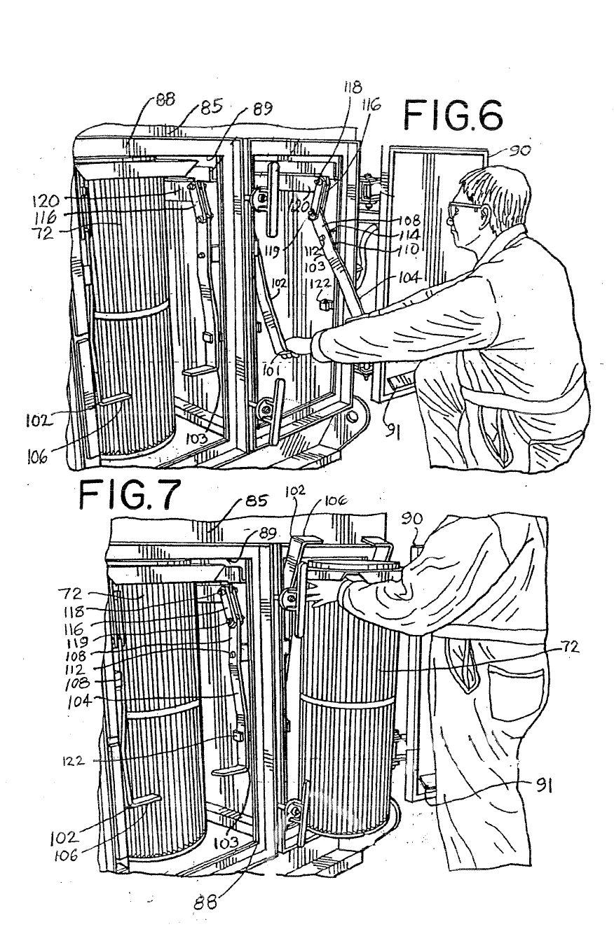

As shown in FIGS. 6-7, the filtering compartment can have a filter lifting and/or moving mechanism 101 with complementary articulated arms 102-103 including a left arm 102 and a right arm 103. Each filter arm can be moveable, pivotal, or swingable, between: (a) a closed locked position, as shown in the left portions of FIGS. 6-7, for lowering, clamping, and preventing removal of the filter 72 and (b) an open position after the upright side door is opened, as shown in the right portions of FIGS. 6-7, for lifting (raising) and permitting removal or replacement of the filter 72. Each of the arms is generally L-shaped with an elongated portion 104 that extends generally upwardly when the arm is in the upright closed position and a shorter manually graspable lateral portion 106 that extends generally horizontally and is cantilevered from the upright portion 104 for providing an abutment stop between the upright tubular filter and the upright side door when the arm is in the upright closed position. The elongated portion can be slightly bent with an upper section 108 (FIG. 6) and a longer lower section 110 that can extend further laterally outwardly and away from the filter than the short upper section 108. The intermediate central portion of the upper section 108 can be pivotally connected via a pivot pin 112 to an end bar 114 providing a bracket. A pair of upper pivotal bars 116 providing an upper bracket can extend between and can be pivotally connected by pivot pins 118-119 to an upper end bar 120 or frame connected to the far end of the housing. The left arm is generally L-shaped as viewed from the front and the right arm is generally L-shaped as viewed from the back or interior of the filter compartment. Hook-shaped lateral brackets 122 can be secured to the accessible side portion of the filtering compartment in proximity to the lateral access opening for abuttingly engaging and holding the elongated portion of the arm when the arms are in the upright closed position. A gasket can be positioned between the housing plate and the filter to seal the filter.

Although embodiments have been shown and described, it is to be understood that various modifications and substitutions, as well as rearrangements of parts, components, equipment, apparatus and process steps, can be made by those skilled in the art without departing from the novel spirit and scope of this disclosure.

1. A vacuum loader for removing particulates from an air streams the vacuum loader comprising:
a hopper having a bin;
a solids-gas separation compartment for separating large particles from the air stream and depositing the large particles in the hopper;
a filtering compartment fluidly communicating with the solids-gas separation compartment, the filtering compartment for removing small particles from the air stream;
a composite silencer base having an absorptive section and a reactive section, the composite silencer base attenuating sound energy from the air stream; and
a blower attached to the composite silencer base,
wherein the blower moves the air stream through the solids-gas separation compartment, the filtering compartment, and the composite silencer base, and exhausts the air stream out of the vacuum loader.

2. The vacuum loader of claim 1, wherein the reactive section reflects at least some of the sound energy back towards a source of the sound energy, thereby reducing the amount of unwanted sound energy exhausting from the vacuum loader with the air stream.

3. The vacuum loader of claim 1, wherein the absorptive section converts at least some of the sound energy to heat energy, thereby reducing the amount of sound energy exhausted from the vacuum loader with the air stream.

4. The vacuum loader of claim 1, wherein the composite silencer base comprises a housing having an inlet and an outlet.

5. The vacuum loader of claim 4, wherein the composite silencer base further comprises a first pipe connected to the inlet and the reactive compartment the first pipe including a plurality of openings.

6. The vacuum loader of claim 5, wherein the composite silencer base further comprises a second pipe connecting the reactive compartment and the absorptive compartment, the second pipe including a plurality of openings.

7. The vacuum loader of claim 1, wherein the composite silencer base comprises a plurality of reactive chambers and a plurality of absorptive chambers.

8. The vacuum loader of claim 1, wherein the absorptive compartment comprises one of a baffle and a louver.

9. The vacuum loader of claim 1, wherein the absorptive compartment comprises a fibrous or sheet sound absorbing material.

10. The vacuum loader of claim 1, wherein the composite silencer base comprises a plurality of pipes.

11. The vacuum loader of claim 1, wherein the air stream passes through the absorptive section before passing through the reactive section.

12. A silencer base and blower package for a vacuum loader, comprising:
a blower; and
a silencer base comprising:
a housing having an inlet and an outlet allowing a fluid to pass through the housing from the inlet to the outlet, the housing adapted to mount the blower thereto;
a reactive sound dampening section comprising a first pipe connected to the inlet for transporting the fluid from the inlet to the reactive sound dampening section, the first pipe including a plurality of openings; and
an absorptive sound dampening section comprising a second pipe connected to the reactive sound dampening section for transporting the fluid from the reactive sound dampening section to the absorptive sound dampening section, the second pipe including a plurality of openings, the second pipe at least partially surrounded by a sound absorbing material.

13. The silencer base and blower package of claim 12, wherein the silencer base housing comprises at least one wall that is at least ⅛ inch thick.

14. The silencer base and blower package of claim 12, wherein the reactive sound dampening section attenuates sound energy below approximately 2000 Hz.

15. The silencer base and blower package of claim 12, wherein the absorptive sound dampening section attenuates sound energy above approximately 2000 Hz.

16. The silencer base and blower package of claim 12, wherein the plurality of openings in the first pipe have at least two different sizes.

17. The silencer base and blower package of claim 12, wherein the plurality of openings in the second pipe have at least two different sizes.

18. The silencer base and blower package of claim 12, wherein the sound absorbing material comprises one of a porous fibrous material and a permeable material.

19. The silencer base and blower package of claim 18, wherein the porous fibrous material comprises one of fiberglass and mineral wool.

20. The silencer base and blower package of claim 12, wherein one of the reactive and absorptive dampening sections comprise a plurality of chambers.

21. The silencer base and blower package of claim 12, wherein the absorptive dampening section includes a baffle.

22. The silencer base and blower package of claim 12, wherein the absorptive dampening section includes a louver.

23. A method of manufacturing a vacuum loader comprising:
attaching a solids-gas separation compartment to a filtering compartment;
attaching the filtering compartment to a blower;
mounting the blower to a composite silencer base;
wherein the composite silencer base includes a reactive sound dampening section and an absorptive sound dampening section.
